(19) United States
(12) Patent Application Publication
(10) Pub. No.: US 2019/0177089 A1
(43) Pub. Date: Jun. 13, 2019

(54) Home Delivery Box

(71) Applicant: Amy Lynn Benefield, Denton, TX (US)

(72) Inventor: Amy Lynn Benefield, Denton, TX (US)

(21) Appl. No.: 16/214,059

(22) Filed: Dec. 8, 2018

Related U.S. Application Data
(60) Provisional application No. 62/596,621, filed on Dec. 8, 2017.

(51) Int. Cl. B65G 11/04; E05C 17/56

(52) U.S. Cl. CPC B65G 11/04; B65G 65/00; E05C 17/56

(57) ABSTRACT

A device for delivery and retrieval of items is disclosed. The device comprising an enclosure, a lid, one or more shelves, and a door. The enclosure is configured to receive and store the items to be delivered to a homeowner. The enclosure includes an upper section and a lower section. The lid covers the upper section of the enclosure, which is accessible by opening the lid. The hinged shelves present within the enclosure is configured to hold the items received from the upper section of the enclosure. The hinged shelves swings down dropping the item to the lower section of the enclosure, and then automatically swings back to its originally position and locks into place. The items are accessible to the homeowner via the door positioned at the lower section of the enclosure. The device keeps the items secure and dry until the homeowner retrieves them.

### BACKGROUND OF THE INVENTION

### A. Technical Field

The present invention generally relates to an item delivery and retrieval device. More specifically, the present invention relates to a device for delivery and retrieval of the items at an unattended location such as to homes, where the residents are away at the time of the delivery.

### B. Description of Related Art

Nowadays, parcel and package delivery services established the ability to deliver packages overnight from practically any source to almost any destination. The packages for home delivery arrive at non-specified time, or mostly were not delivered on expected delivery time. The delivery services deliver packages during the daytime when a consumer, a homeowner, or recipient is not at home.

Currently, media has been reporting a rise in theft of the packages left at the door of the residences especially during holiday and gift giving seasons. The security of such packages is always a concern. The adaption of security cameras and other technology are few measures being taken to curb such instances. To initiate a secured delivery of the items, the delivery personnel is provided with a means to have an easy access to an enclosure owned by the consumer. The enclosure is configured to receive the items delivered by the delivery personnel, when the consumer personally cannot receive the items. Thus, the delivery personnel is given a mechanical key, active remote such as a button transmitter, access code, combination, etc., which unlocks the enclosure. However, upon giving such access to the delivery personnel increases the security risk associated with the items present or stored within the enclosure.

Further, the security of the enclosure is dependent upon and susceptible to the security procedures of the delivery personnel. The enclosure could be subject to unauthorized access by the delivery personnel i.e., when not associated with the delivery or drop-off of an item. A key provided to the delivery personnel could be duplicated, or lost by the delivery personnel. Further, the requirement of the key to be given to the delivery personnel may be logistically cumbersome. This is because the same delivery personnel is to be enlisted by the consumer prior to the initiation of the delivery process. Hence, a sender may be restricted in its usage of its own preferred delivery personnel and may have to use and coordinate with the regular delivery personnel of the consumer.

Currently, theft of delivered packages or items is rampant. Most porches/stoops in a house are unprotected, allowing the thief to amble up, grab, and then walk away with the package or items. Several methods of protection are being employed by the consumers to hinder the theft associated with the delivered items. One such measures employed by the consumer is the use of security cameras in a verandah, or an area to which the items are delivered. The camera is configured to send a warning to the consumer when a person has crossed the arbitrary security threshold. Further, a message is sent to the consumer's phone so that they can observe the video image of the intruder. The video image is also stored so the authorities can observe the perpetrator. The cameras used for such activities come in many configurations, however, they are unable to protect the delivered items being stolen. They can only passively view the theft in progress. The camera also allows bi-lateral voice communication so that the consumer could talk to the thief and, hopefully, convince them not to take the delivered item or package(s). With more and more online purchases being executed, the loss of delivered package or items is increasing day by day, if the delivered items are unattended by the consumer.

In light of the foregoing, there is a need for a solution that enables a secured delivery of the items to the consumer, hindering the access of the delivered items stored within the enclosure. Further, there is a need for a device that keeps the delivered items secured until received by the consumer.

### SUMMARY OF THE INVENTION

The present invention relates to a device for delivery and retrieval of an item or a package at an unattended location such as to homes, where the residents or homeowners are away at the time of the delivery. The device of the present invention prevents the delivered items from being stolen when unattended by the homeowner.

The device of the present invention resolves most of problems associated with the delivery of the items or packages by delivery personnel at unattended locations such as but not limited to homes or place of business. In an embodiment, the device comprises an enclosure, a lid, one or more shelves, and a door. The enclosure is configured to receive and store the items delivered by a delivery personnel. The enclosure with multiple sides defines an interior. The interior of the enclosure includes an upper section or upper chamber and a lower section or lower chamber. The packages are received into the device from the upper section of the enclosure, which is accessible to the delivery personnel for delivering the packages. The received packages are stored within the lower section of the enclosure. The enclosure is configured to receive several or multiple deliveries at once.

In an embodiment, the lid covers the upper section of the enclosure. A silicone rubber gasket all around an interior periphery of the lid seals against the upper section of the enclosure. The lid is weatherproof and therefore the enclosure remains dry, dust, and debris free, protecting the packages, until the packages are removed from the device. In one embodiment, an electromagnetic lock is used to close the lid. The lid is opened on activation of the electromagnetic lock. To activate the electromagnetic lock, a label having a barcode is scanned using a barcode scanner. The label bearing the bar code is attached to the top of the device. In order to drop the package into the enclosure, the delivery personnel have to scan the bar code provided on the label on the top of the device. The lid opens as the bar code matches, and the package is placed inside the enclosure. The lid is automatically locked once the delivery of the package is completed.

In one embodiment, the shelves positioned within the enclosure are configured to hold the packages dropped into the enclosure. The shelves drop down the package into the lower section of the enclosure, after the weather protective lid is lowered. When the lid is lifted initially, the shelves remain fixed, allowing the delivery personnel to place the package on them within the enclosure. The shelves drops down allowing the package to fall to the lower section of the enclosure as the lid is shut completely after the placement of the package, and then rebound to the fixed secure position. A coating is provided on the lid and the enclosure making them resistant to rust, corrosion, scratch and UV rays.

Other objects, features and advantages of the present invention will become apparent from the following detailed description. It should be understood, however, that the detailed description and the specific examples, while indicating specific embodiments of the invention, are given by way of illustration only, since various changes and modifications within the spirit and scope of the invention will become apparent to those skilled in the art from this detailed description.

### BRIEF DESCRIPTION OF DRAWINGS

The foregoing summary, as well as the following detailed description of the invention, is better understood when read in conjunction with the appended drawings. To illustrating the invention, exemplary constructions of the invention are shown in the drawings. However, the invention is not limited to the specific methods and structures disclosed herein. The description of a method step or a structure referenced by a numeral in a drawing is applicable to the description of that method step or structure shown by that same numeral in any subsequent drawing herein.

FIG. 1 is a perspective view of a device, according to an embodiment of the present invention;

FIG. 2 illustrates a package being dropped into an enclosure of the device, according to an embodiment of the present invention;

FIG. 3A exemplary illustrates placement of the package on a shelf provided within the enclosure, according to an embodiment of the present invention;

FIG. 3B illustrates the package being dropped into a lower section of the enclosure, according to an embodiment of the present invention;

FIG. 4A illustrates retrieval of the package being from the lower section of the enclosure, according to an embodiment of the present invention;

FIG. 4B exemplary illustrates the retrieval of the package by a homeowner from the device, according to an embodiment of the present invention;

FIG. 5A is a front view of the device, according to an embodiment of the present invention;

FIG. 5B illustrates a reinforcing bolt down pad, according to an embodiment of the present invention;

FIG. 5C illustrates a cross sectional view of the reinforced bolt down pad along the line A-A′ of FIG. 5B, according to an embodiment of the present invention; and

FIG. 5D is a side view of the device, according to an embodiment of the present invention.

### DETAILED DESCRIPTION OF EMBODIMENTS

A description of embodiments of the present invention will now be given with reference to the Figures. It is expected that the present invention may be embodied in other specific forms without departing from its spirit or essential characteristics. The described embodiments are to be considered in all respects only as illustrative and not restrictive.

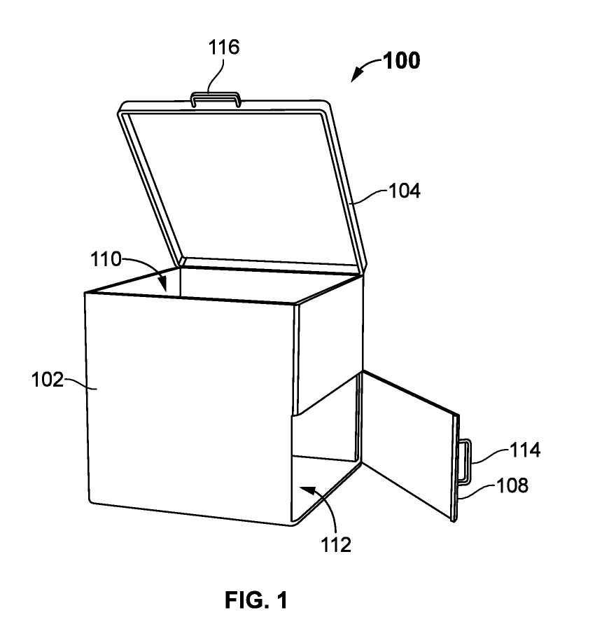

FIG. 1 is a perspective view of a device 100 according to an embodiment of the present invention. The device 100 is designed or constructed in such a manner that, it fits on a front stoop or a porch of a home or a place of business. The device 100 is secured to the porch or the stoop of a floor using the supplied security hardware. The device 100 facilitates secure delivery of a package 118 at an unattended location such as to homes, where the residents are away at the time of the delivery. In an embodiment, the device 100 comprises an enclosure, or a box, or a container, or a cabinet 102, a lid 104, one or more shelves 106, and a door 108. The enclosure 102 of the device 100 with multiple sides defines an interior. The interior of the enclosure 102 includes an upper section or upper chamber 110, and a lower section or lower chamber 112. The enclosure 102 is configured to receive, and store the packages 118 delivered by a delivery personnel. In one embodiment, the upper section 110, and the lower section 112 are two separate sections present within the enclosure 102. The packages 118 are received into the device 100 from the upper section 110 of the enclosure 102, which is accessible by the delivery personnel for delivering the packages by opening the lid 104. The received packages are stored within the lower section 112 of the enclosure 102. The enclosure 102 receives several deliveries. The packages 118 delivered recently or previously are protected within the enclosure 102 until an individual or a homeowner, or a renter, or a recipient or a consumer removes the item or the package 118 from the lower section 112 of the enclosure 102.

In one embodiment, the enclosure 102 is made of steel. In another embodiment, the enclosure 102 is fabricated from ⅛″ thick cold rolled, high strength steel. The enclosure 102 shape is cut out of the sheet stock using a computer controlled water jet-machining center. After the enclosure 102 shape is cut off, it is formed on a flywheel press in a specialty die. It is then placed in a jig, and robotically welded to make a secure enclosure 102. In another embodiment, 3/16″ thick cold rolled steel ovals are cut out of sheet steel stock, and these are robotically welded in place to reinforce the bolt down pads in a base and back of the enclosure 102. The lid 104 is stamped to shape after being cut out of the sheet material using the water jet-machining center. A continuous hinge is welded in place on the lid 104, and the enclosure 102. In an embodiment, the lid 104 is made of steel.

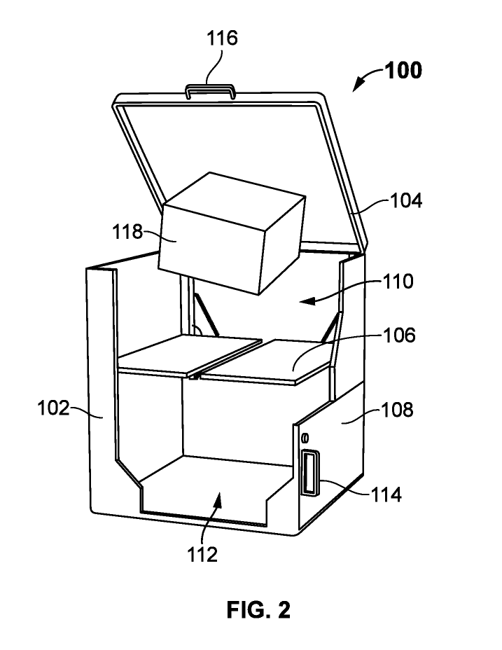

In an embodiment, the lid 104 covers the upper section 110 of the enclosure 102. The lid 104 is accessible to the delivery personnel, and the package 118 is placed inside the enclosure 102 by opening the lid 104. The lid 104 comprises a handle 116. The handle 116 enables the delivery personnel to open and close the lid 104. A silicone rubber gasket all around an interior periphery of the lid 104 seals against the upper section 110 of the enclosure 102. FIG. 2 illustrates the package 118 being dropped into an enclosure 102 of the device 100, according to an embodiment of the present invention.

The lid 104 is weatherproof, hence the enclosure 102 remains dry, dust, and debris free, protecting the package 118, until the package 118 are removed from the device 100. In an embodiment, the lid 104, and the enclosure 102 are painted with aliphatic polyurethane coating, which is extremely durable. In one embodiment, the coating on the lid 104, and the enclosure 102 could be of any polymer material. The coating is supplied in almost any vibrant color, so a distinctive color could be chosen to enhance the device 100 recognition factor, which dramatically improves the market adoption of the device 100. The coating provided on the lid 104 and the enclosure 102 is rust, corrosion, scratch and UV resistant, making it an optimum coating for this application.

In one embodiment, the lid 104 is locked or closed using an electromagnetic lock. A label bearing the barcode is provided at the top of the device 100. To activate or open the lock, the delivery personnel has to scan the label using a barcode scanner. The lock is activated as the bar code on the label matches on scanning, thereby enabling the delivery personnel to drop the package 118 inside the enclosure 102. The lid 104 is automatically locked, once the delivery of the package 118 is complete. This alternative method could eliminate an interior hinged shelves or flaps.

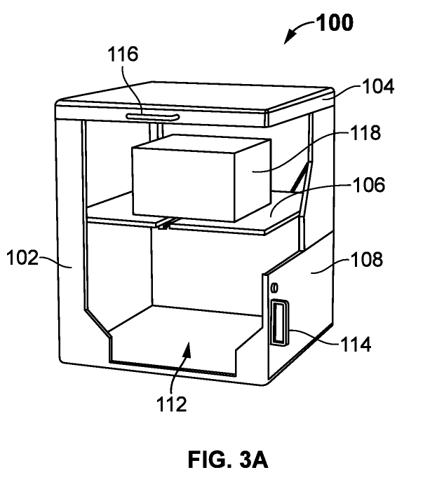

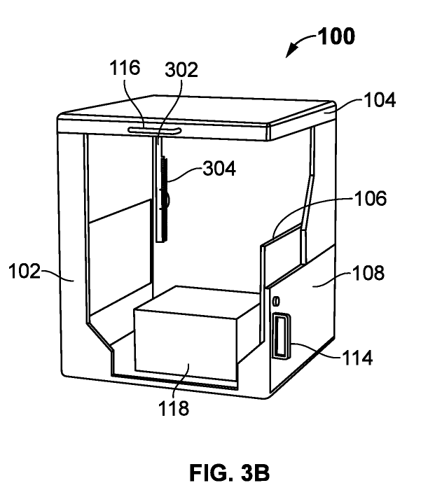

In an embodiment, the shelves 106 positioned within the enclosure 102 are configured to hold the package 118 dropped into the enclosure 102. The shelves 106 are positioned such that, it separates the upper section 110, and the lower section 112 of the enclosure 102. In one embodiment, the shelves 106 are cut to shape using 1/16″ thick steel material. After cutting, they are stamped on a flywheel press, and a continuous hinge is welded onto a bottom edge of the shelves 106. Further, the hinges are robotically welded into position after fabrication. FIG. 3A exemplary illustrates placement of the package 118 on the shelves 106 provided within the enclosure 102, according to an embodiment of the present invention. In another embodiment, the shelves 106 are hinged shelves. In use, the delivery personnel lifts the lid 104 for dropping the package 118 into the enclosure 102. The package 118 is hold by the shelves 106, before the package 118 is dropped into the lower section of the enclosure 102. In an embodiment, a security latch 302 comprising a spring 304 is engaged to the shelves 106. Further, the shelves 106 are spring loaded 304. The springs 304 in the hinged shelves 106 helps in drop down of the packages into the lower section 110 of the enclosure 102. As the lid 104 is closed, after placing the package 118 into the enclosure 102, the security latch 302 is released enabling the shelves 106 to drop down, forced by the weight of the package 118. The package 118 is then dropped to the lower section 112 of the enclosure 102, and the shelves 106 rebound, settle for about 30 seconds, and the security latch 302 engages locking the shelves 106 in place. In one embodiment, the hinged shelves 106 are activated as the lid 104 is closed. The shelves 106 are very durable and the mating surfaces are small, so they are difficult to damage enough to remove any packages below. The springs 304 in the security latch 302 are balanced within the shelves 106 weight to allow them to be slightly positive upward when no package resides on the shelves 106. The latch 302 comprising the spring 304 is commercially available, but have to be engaged properly within the enclosure 102 as mentioned above to serve the objective of the present invention.

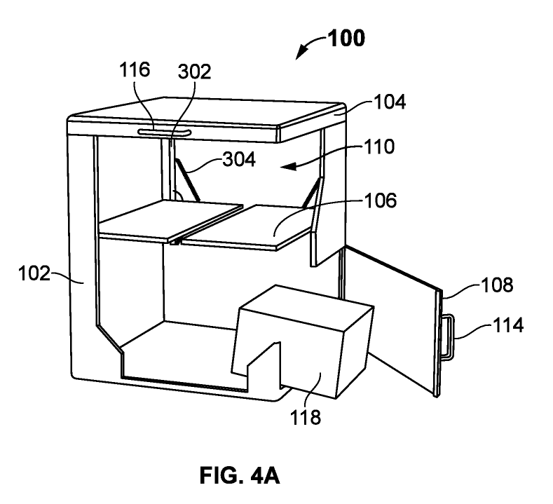

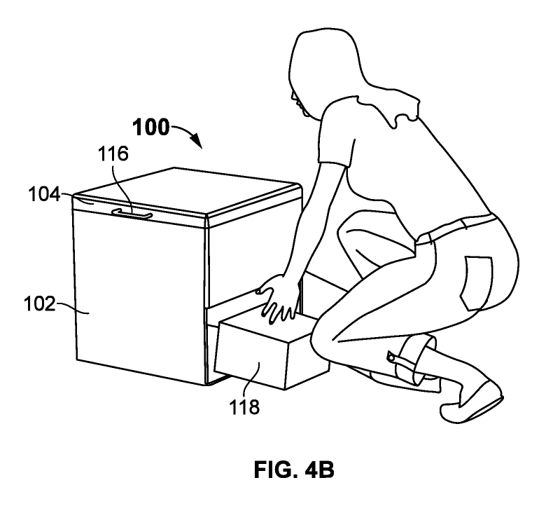

FIG. 3B illustrates the package 118 being dropped into the lower section 112 of the enclosure 102, according to an embodiment of the present invention. In an embodiment, the lower section 112 of the enclosure 110 includes the door 108. The lower section 112 is accessible to the homeowner by unlocking the door 108. The door 108 is a side door located at one side of the lower section 112. A handle 114 provided on the door 108 enables an easy access to the lower section 112 of the enclosure 102. The homeowner could retrieve the package 118 any time by unlocking the door 108. The door 108 protects the package 118 from being stolen, when the package 118 is delivered in the absence of the homeowner. FIG. 4A illustrates retrieval of the package from the lower section 112 of the enclosure, 102 according to an embodiment of the present invention. In one embodiment, the door 108 is assembled after being cut out of the ⅛″ sheet steel by the water jet-machining center, the supports, the hinge is robotically welded in place, and the door is painted with the enclosure 102 and the lid 104. The commercially available lock components are attached, and bolted in place after the door 108 is painted.

In an embodiment, the device 100 is supplied with a security system that prevents the lid 104 from being opened, if the shelves 106 rotate downward, and cannot return to the horizontal locked position. In such scenario, a lid latch engages to the upper section 110 of the enclosure 102, and the lid latch is not released until the packages 118 are removed from the lower section 112 of the enclosure 102, and the shelves 106 are allowed to return to the horizontal and latched position enabling the device 100 to work normally.

In some embodiments, the enclosure 102 is blow molded using plastic material. In one embodiment, the plastic material is polypropylene. The enclosure 102, the lid 104, the door 108, and the shelves 106 are separately molded, and assembled using the same commercially available components as for the device 100 made using steel. The plastic material used for molding the enclosure 102 and the lid 104 is pre-colored. The painting of the enclosure 102 and the lid 104 is not required as done for the device 100 made of steel.

FIG. 4B exemplary illustrates the retrieval of the package 118 by the homeowner from the device 100, according to an embodiment of the present invention. The delivery personnel drop the package 118 to be delivered from the upper section 110 of the enclosure 102. The package 118 on being dropped into the upper section 102, initially rest on the shelves 106 for few seconds, and then finally drops into the lower section 112 of the enclosure 102. The hinged shelves 106 automatically swings up to their original position, and locks into place as the package 118 is dropped into the lower section 112 of the enclosure 102. The lower section 112 of the enclosure 102 is not accessible, when the upper section 110 of the enclosure 102 is open. The package 118 is accessed via the door 108 located at one side of the lower section 112 of the enclosure 102. The homeowner unlocks the door 108, to retrieve the package 118 dropped into the device 100. The door 108 is locked when not in use, and is accessible only by the homeowner. The lower section 112 of the enclosure 102 is not accessible to the delivery personnel. In an embodiment, the lower section 112 could store and secure multiple packages delivered by the delivery personnel until retrieved by the homeowner.

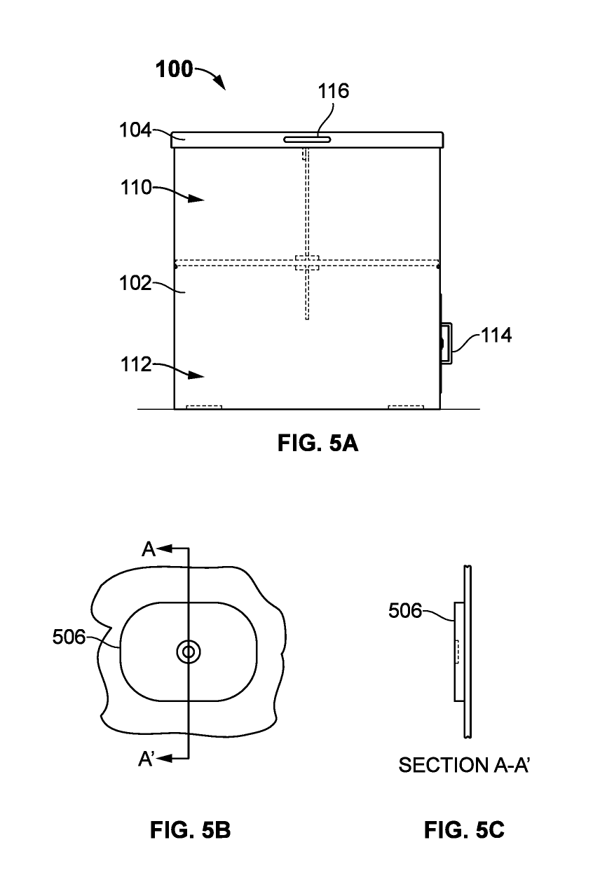

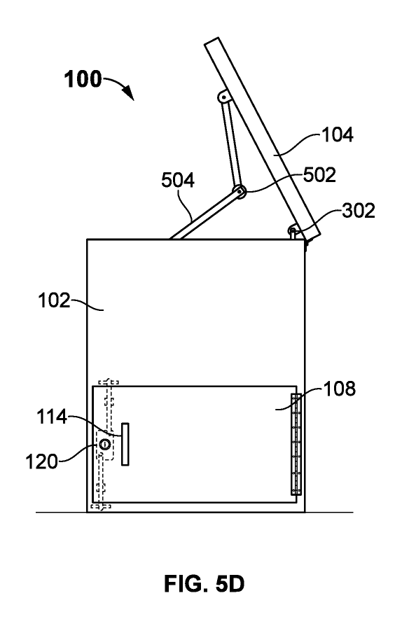

FIG. 5A is a front view of the device 100, according to an embodiment of the present invention. The enclosure 102 is constructed using high strength cold rolled steel sheet. The shape of the enclosure 102 is formed after being cut out of the sheet, and robotically welded to make the watertight, tamper resistant enclosure 102. The weather resistance is slightly compromised by a security mounting holes on a bottom and a back of the enclosure 102, and shipped with tight fitting plastic plugs to solve the above problem. FIG. 5B illustrates a reinforcing bolt down pad, according to an embodiment of the present invention. In an embodiment, the reinforcing bolt down pads 506 are formed, which are welded to an interior base of the enclosure 102, to enable the affixing of the device 100 to the porch or the stoop floor. FIG. 5C illustrates a cross sectional view of the reinforced bolt down pad 506 along the line A-A′ of FIG. 5B, according to an embodiment of the present invention.

In an embodiment, the shelves 106 are hinged at outer edges. When the lid 104 is lifted initially to deliver the package 118, the shelves 106 remains in a fixed secured position, allowing the delivery personnel to place the package 118 on the shelves 106, within the enclosure 102. However, as the lid 104 is shut completely after the placement of the package 118, the shelves 106 drops down momentarily allowing the package 118 to fall to the lower section 112 of the enclosure 102. The shelves 106 then rebound to the fixed secure position. The lid 104 shields the interior of the enclosure 102 from weather, dust, and airborne debris, keeping the package 118 clean and dry until removed from the device 100.

FIG. 5D is a side view of the device 100, according to an embodiment of the present invention. In an embodiment, the lid 104 is propped up through a friction wheel 502, and a support arm 504 mounted on both sides of the enclosure 102. The friction wheel 502, and the support arm 504, fold against the interior sides of the enclosure 102 when the lid 104 is closed. The silicon rubber gasket all around the interior periphery of the lid 104, seals against the upper section 110 of the enclosure 102. In an embodiment, the security latch 302 is operated by the lid 104, as the lid 104 is opened, and closed by the delivery personnel. The enclosure 102 is coated with aliphatic polyurethane coating for providing wear, UV, corrosion resistance. The delivered package is removed from the secure location (lower section 112) within the enclosure 102, and the door 108 is re-closed after the retrieval of the package 118. In one embodiment, the door 108 is securely locked using a tamper resistant keyed tumbler lock 120, which has two hardened bars that slide into receivers welded into an interior surface of the enclosure 102, preventing unwarranted removal of the package.

In an embodiment, the device 100 is used for secured delivery and retrieval of packages at unattended locations such as home or place of business. Additionally, the device 100 facilitates the delivery of multiple packages at once. Packages of different size are also accommodated within the device 100. The device 100 provides a peace of mind to the homeowner expecting the packages to be delivered in the front door of the home. The device 100 is recognizable and easily operated by delivery personnel, and the homeowners for retrieving the delivered packages. The device 100 keeps the lower section 112 secure, while allowing further deliveries into the upper section 110 of the enclosure 102. The lid 104 allows the packages to be dropped into the device 100. The hinged shelves 106 drops the packages into the secured lower section 112. Further, the hinged shelves 106 are activated as the lid 104 is closed enabling the drop of the package to the lower section 112. The door 108 could be locked when not in use restricting the access of the lower section 112 of the enclosure 102. Further, the lower section 112 is not accessible from the upper section 110 of the enclosure 102. The device 100 hides and keeps secure the delivery packages left at the front of the home. Constructed of sturdy and tamper resistance material the device 100 keeps the packages secure and dry until the recipient or homeowners retrieve them.

The foregoing description comprise illustrative embodiments of the present invention. Having thus described exemplary embodiments of the present invention, it should be noted by those skilled in the art that the within disclosures are exemplary only, and that various other alternatives, adaptations, and modifications may be made within the scope of the present invention. Merely listing or numbering the steps of a method in a certain order does not constitute any limitation on the order of the steps of that method. Many modifications and other embodiments of the invention will come to mind to one skilled in the art to which this invention pertains having the benefit of the teachings presented in the foregoing descriptions. Although specific terms may be employed herein, they are used only in generic and descriptive sense and not for purposes of limitation. Accordingly, the present invention is not limited to the specific embodiments illustrated herein.

What is claimed is:

1. A home delivery box, comprising:
an enclosure with multiple sides defining an interior;
at least two spring loaded hinged shelves extend from at least two opposite sides of the interior defining an upper chamber and a lower chamber, wherein the at least two hinged shelves comprises a security latch, and
a lid hingedly disposed at one side of the enclosure to provide access to the upper chamber to deposit a package by a delivery personnel,
wherein the at least two hinged shelves on receiving the package and on closure of the upper chamber configured to swing down to pass the package from the upper chamber to the lower chamber.

2. The home delivery box of claim 1, wherein the lid comprises an electromagnetic lock.

3. The home delivery box of claim 1, further comprises a friction wheel and a support arm mounted on the upper chamber of the enclosure to prop up the lid.

4. The home delivery box of claim 1, wherein the at two hinged shelves configured to bounce back to rest position on passing down the package via the security latch.

5. The home delivery box of claim 1, wherein an interior periphery of the lid comprises a gasket to seal an opening of the upper chamber.

6. The home delivery box of claim 1, further comprises a door disposed at one side of the enclosure to provide access to the lower chamber to retrieve the package.

7. The home delivery box of claim 6, wherein the door comprises a tamper resistance keyed tumbler lock.

8. The home delivery box of claim 6, wherein the door further comprises a handle.

9. The home delivery box of claim 1, wherein the lid further comprises a handle.

10. The home delivery box of claim 1, wherein the enclosure and lid are coated with aliphatic polyurethane.

11. The home delivery box of claim 1, wherein the enclosure is made of steel.

12. The home delivery box of claim 1, wherein the enclosure is made of plastic.
